(19) United States
(12) Patent Application Publication
(10) Pub. No.: US 2015/0029920 A1
(43) Pub. Date: Jan. 29, 2015

(54) Power Saving UL DTX and DL DRX Techniques for Multi-Flow Operation in HSPA

(71) Applicant: NOKIA SOLUTIONS AND NETWORKS OY, Espoo (FI)

(72) Inventors: Hans Thomas Hoehne, Helsinki (FI); Jani Matti Johannes Moilanen, Helsinki (FI); Karri Markus Ranta-Aho, Espoo (FI); Alexander Sayenko, Espoo (FI); Jeroen Wigard, Klarup (DK)

(21) Appl. No.: 14/363,114

(22) PCT Filed: Nov. 8, 2011
(86) PCT No.: PCT/EP2011/069651

§ 371 Date: Aug. 22, 2014

(51) Int. Cl. H04W 52/02; H04L 1/18

(52) U.S. Cl. CPC H04W 52/0209; H04L 1/1812
USPC 370/311

(57) ABSTRACT

An apparatus includes multi-flow communicating means adapted to perform a communication with a UE including a portion of a multi-flow communication to the UE; evaluating means adapted to evaluate the communication with the UE; and providing means adapted to provide a DTX/DRX information based on the evaluation. The DTX/DRX information is related to at least one of a discontinuous transmission state and a discontinuous reception state of the UE. The instructing means is adapted to instruct the multi-flow communicating means to send DTX/DRX activation request with respect to the at least one of the discontinuous transmission state and the discontinuous reception state according to the DTX/DRX information to the UE. The storing means is adapted to store a status information, wherein the status information includes the at least one of the discontinuous transmission state and the discontinuous reception state corresponding to the instruction by the instructing means.

### FIELD OF THE INVENTION

The present invention relates to an apparatus, a method, a system, and a computer program product related to improving the multi-flow communication. More particularly, the present invention relates to an apparatus, a method, a system, and a computer program product for discontinuous transmission and/or reception in a multi-flow communication.

### BACKGROUND OF THE INVENTION

### Abbreviations

### 3GPP Third Generation Partnership Project

### CFN Connection Frame Number

### CRNC Controlling RNC

### DCH Dedicated Channel

### DC-HSUPA Dual Carrier HSUPA

### DL Downlink

### DRX Discontinuous Reception

### DSCH Downlink Shared Channel

### DTX Discontinuous Transmission

### FACH Forward Access Channel

### HARQ Hybrid Automatic Repeat Request

### HSDPA High Speed Downlink Packet Access

### HSUPA High Speed Uplink Packet Access

HS-DPCCH High Speed Dedicated Physical Control Channel (HSDPA UL control channel)
HS-SCCH High Speed Secondary Control Channel (HSDPA DL control channel)

### HSPA High Speed Packet Access

### LTE Long Term Evolution

### PCH Physical Channel

### RAN Radio Access Network

### RAT Radio Access Technology

### Rel Release

### RLC Radio Link Control

### RNC Radio Network Controller

### RRC Radio Resource Control

### RRM Radio Resource Management

### SFN System Frame Number

### TCP Transmission Control Protocol

### TS Technical Specification

### UE User Equipment

### UL Uplink

### UMTS Universal Mobile Telecommunications System

Current development and standardization of wireless systems is characterized by a number of dimensions where further enhancements are considered. One of those dimensions is the multi-point transmission where data is transmitted from more than one transmission point, e.g., base station. One of the multi-point transmission schemes, which hence will be referred to as Multi-flow, is characterized by splitting the application level data into several flows and sending each flow from a particular base station. The 3GPP HSPA track has approved the Multi-flow work item aiming at standardizing that mode of operation for Rel-11.

With the aforementioned Multi-flow configuration, a few technical challenges arise regarding achieving a good trade-off between keeping all the transmission cells active for a particular Multi-flow capable UE and ensuring a low battery consumption.

In the multi-point transmission scheme called Multi-flow, which is characterized by splitting the application level data into several independent streams and sending them over different wireless links, e.g., cells, the nature of this transmission scheme exploits the simple fact that the neighbouring cells are not busy all the time with serving UEs under their control. As a result, unused transmission opportunities can help or assist UEs residing at the cell edge of the neighbour cells, thus improving their cell edge performance. Such an ap-proach assumes that the Multi-flow capable UE must be kept most of the time configured with the Multi-flow to exploit moments of the uneven cell load. Otherwise, constant (re-)configuring UEs with the Multi-flow operation will result in the increased signalling load and reduced scheduling freedom. In the legacy case, the network can switch a UE from the CELL_DCH state to a more power efficient CELL_FACH or CELL_PCH state. Since the Multi-flow operation will be limited to the CELL_DCH state only, switching to a different state is not efficient for the reason of loosing the Multi-flow scheduling flexibility and increased signalling load.

In the prior art, UL DTX and DL DRX schemes are defined for the HSPA CELL_DCH state. The network can use them to optimize for the UE battery consumption without moving the UE to one of the more power efficient states. However, conventionally, the UL DTX and DL DRX are defined for the legacy single-site transmission operation. Even when a UE is configured with the mul-ti-carrier operation, there is a common DRX/DTX state machine across all the configured carriers.

In the DTX and DRX schemes, transmissions/receptions are allowed to be scheduled for only a subset of all the possible transmission/reception times at normal operation, when DTX and/or DRX schemes are not applied.

In R2-113959, one of the proponents proposed to disallow the usage of the DL DRX for Multi-flow without mentioning at all the position on the UL DTX. In R2-114899, the same proponent, as of R2-113959, has changed its mind and considered a possibility of DTX/DRX for the Multi-flow operation.

### SUMMARY OF THE INVENTION

It is an object of the present invention to improve the prior art.

In particular, it is an object to allow for network controlled mobility without strongly increasing the power consumption of the UE.

According to a first aspect of the invention, there is provided an apparatus, comprising multi-flow communicating means adapted to perform a communication with a user equipment including a portion of a multi-flow communication to the user equipment; evaluating means adapted to evaluate the communication with the user equipment; providing means adapted to provide a DTX/DRX information based on the evaluation, wherein the DTX/DRX information is related to at least one of a discontinuous transmission state and a discontinuous reception state of the user equipment; instructing means adapted to instruct the multi-flow communicating means to send an UE DTX/DRX activation request with respect to the at least one of the discontinuous transmission state and the discontinuous reception state according to the DTX/DRX information to the user equipment; storing means adapted to store a status information upon the instructing by the instruction means, wherein the status information comprises the at least one of the discontinuous transmission state and the discontinuous reception state corresponding to the instruction by the instructing means.

In the apparatus, the instructing means may be adapted to instruct the multi-flow communicating means based on the evaluation.

In the apparatus, the providing means may be adapted to provide the DTX/DRX information to a control device, and the instructing means may be adapted to instruct the multi-flow communicating means based on an activation request received from the control device.

The apparatus may further comprise offset calculating means adapted to calculate a relative offset time from a first offset time of the multi-flow communicating means and a second offset time of a second base station device performing another portion of the multi-flow communication with the user equipment; calculating means adapted to calculate a time when the user equipment is ready to receive the multi-point communication based on the first offset time; wherein the multi-flow communicating means may be adapted to transmit to the user equipment only at the calculated time if the status information comprises the discontinuous reception state, and the DTX/DRX information may comprise an offset information related to the relative offset time.

The apparatus may further comprise HARQ detecting means adapted to detect an automatic repeat request activity from the user equipment; and status changing means adapted to change the stored status information to neither of the discontinuous transmission state and the discontinuous reception state if the automatic repeat request activity is detected.

The apparatus may further comprise activation time calculating means adapted to calculate an activation time based on a time required to distribute the DTX/DRX information to a second base station device performing another portion of the multi-flow communication, wherein the DTX/DRX information may comprise the activation time, and the instructing means may be adapted to instruct the multi-flow communicating means only after the activation time has elapsed after the DTX/DRX information was provided.

In the apparatus, the activation request may comprise an activation time, and the instructing means may be adapted to instruct the multi-flow communicating means only after the activation time has elapsed after the activation request was received.

The apparatus may further comprise analyzing means adapted to analyze a channel quality indicator in a first way if the status information comprises the discontinuous transmission state, and in a second way different from the first way if the status information does not comprise the discontinuous transmission state, wherein the channel quality indicator may be received from the user equipment.

According to a second aspect of the invention, there is provided an apparatus, comprising multi-flow communicating processor adapted to perform a communication with a user equipment including a portion of a multi-flow communication to the user equipment; evaluating processor adapted to evaluate the communication with the user equipment; providing processor adapted to provide a DTX/DRX information based on the evaluation, wherein the DTX/DRX information is related to at least one of a discontinuous transmission state and a discontinuous reception state of the user equipment; instructing processor adapted to instruct the multi-flow communicating processor to send an UE DTX/DRX activation request with respect to the at least one of the discontinuous transmission state and the discontinuous reception state according to the DTX/DRX information to the user equipment; storing processor adapted to store a status information upon the instructing by the instruction processor, wherein the status information comprises the at least one of the discontinuous transmission state and the discontinuous reception state corresponding to the instruction by the instructing processor.

In the apparatus, the instructing processor may be adapted to instruct the multi-flow communicating processor based on the evaluation.

In the apparatus, the providing processor may be adapted to provide the DTX/DRX information to a control device, and the instructing processor may be adapted to instruct the multi-flow communicating processor based on an activation request received from the control device.

The apparatus may further comprise offset calculating processor adapted to calculate a relative offset time from a first offset time of the multi-flow communicating processor and a second offset time of a second base station device performing another portion of the multi-flow communication with the user equipment; calculating processor adapted to calculate a time when the user equipment is ready to receive the multi-point communication based on the first offset time; wherein the multi-flow communicating processor may be adapted to transmit to the user equipment only at the calculated time if the status information comprises the discontinuous reception state, and the DTX/DRX information may comprise an offset information related to the relative offset time.

The apparatus may further comprise HARQ detecting processor adapted to detect an automatic repeat request activity from the user equipment; and status changing processor adapted to change the stored status information to neither of the discontinuous transmission state and the discontinuous reception state if the automatic repeat request activity is detected.

The apparatus may further comprise activation time calculating processor adapted to calculate an activation time based on a time required to distribute the DTX/DRX information to a second base station device performing another portion of the multi-flow communication, wherein the DTX/DRX information may comprise the activation time, and the instructing processor may be adapted to instruct the multi-flow communicating processor only after the activation time has elapsed after the DTX/DRX information was provided.

In the apparatus, the activation request may comprise an activation time, and the instructing processor may be adapted to instruct the multi-flow communicating processor only after the activation time has elapsed after the activation request was received.

The apparatus may further comprise analyzing processor adapted to analyze a channel quality indicator in a first way if the status information comprises the discontinuous transmission state, and in a second way different from the first way if the status information does not comprise the discontinuous transmission state, wherein the channel quality indicator may be received from the user equipment.

According to a third aspect of the invention, there is provided an apparatus, comprising multi-flow communicating means adapted to perform a communication with a user equipment including a portion of a multi-flow communication to the user equipment; storing means adapted to store, upon a received DTX/DRX information related to at least one of a discontinuous transmission state and a discontinuous reception state, a status information indicating that the user equipment is in the at least one of the discontinuous transmission state and the discontinuous reception state.

In the apparatus, the multi-flow communicating means may be adapted to transmit to the user equipment at transmission times if the status information does not comprise the discontinuous reception state, and at a subset of the transmission times if the status information comprises the discontinuous reception state.

In the apparatus, the DTX/DRX information may comprise an offset information about a time offset, and the apparatus may further comprise calculating means adapted to calculate the subset of times based on the offset information.

The apparatus may further comprise HARQ detecting means adapted to detect an automatic repeat request activity from the user equipment; and status changing means adapted to change the stored status information to neither of the discontinuous transmission state and the discontinuous reception state if the automatic repeat request activity is detected.

The apparatus may further comprise analyzing means adapted to analyze a channel quality indicator in a first way if the status information comprises the discontinuous transmission state, and in a second way different from the first way if the status information does not comprise the discontinuous transmission state, wherein the channel quality indicator may be received from the user equipment.

According to a fourth aspect of the invention, there is provided an apparatus, comprising multi-flow communicating processor adapted to perform a communication with a user equipment including a portion of a multi-flow communication to the user equipment; storing processor adapted to store, upon a received DTX/DRX information related to at least one of a discontinuous transmission state and a discontinuous reception state, a status information indicating that the user equipment is in the at least one of the discontinuous transmission state and the discontinuous reception state.

In the apparatus, the multi-flow communicating processor may be adapted to transmit to the user equipment at transmission times if the status information does not comprise the discontinuous reception state, and at a subset of the transmission times if the status information comprises the discontinuous reception state.

In the apparatus, the DTX/DRX information may comprise an offset information about a time offset, and the apparatus may further comprise calculating processor adapted to calculate the subset of times based on the offset information.

The apparatus may further comprise HARQ detecting processor adapted to detect an automatic repeat request activity from the user equipment; and status changing processor adapted to change the stored status information to neither of the discontinuous transmission state and the discontinuous reception state if the automatic repeat request activity is detected.

The apparatus may further comprise analyzing processor adapted to analyze a channel quality indicator in a first way if the status information comprises the discontinuous transmission state, and in a second way different from the first way if the status information does not comprise the discontinuous transmission state, wherein the channel quality indicator may be received from the user equipment.

According to a fifth aspect of the invention, there is provided an apparatus, comprising controlling means adapted to control a first communication of a first base station device with a user equipment and a second communication of a second base station device different from the first base station device with the user equipment, wherein the first communication and the second communication each comprise a respective, different, portion of a multi-flow communication with the user equipment; distributing means adapted to distribute an activation request related to at least one of a discontinuous transmission state and a discontinuous reception state of the user equipment to the first base station device and the second base station device.

The apparatus may further comprise offset calculating means adapted to calculate a relative offset time from a first offset time of the first base station device and a second offset time of the second base station device; wherein the activation request may comprise an offset information based on the relative offset time.

The apparatus may further comprise activation time calculating means adapted to calculate an activation time based on a time required to distribute the activation request to the first and second base station devices, wherein the distributing means may be adapted to provide the activation time to the first and second base station devices.

In the apparatus, the distributing means may be adapted to distribute the activation request based on a DTX/DRX information received from the first base station device.

According to a sixth aspect of the invention, there is provided an apparatus, comprising controlling processor adapted to control a first communication of a first base station device with a user equipment and a second communication of a second base station device different from the first base station device with the user equipment, wherein the first communication and the second communication each comprise a respective, different, portion of a multi-flow communication with the user equipment; distributing processor adapted to distribute an activation request related to at least one of a discontinuous transmission state and a discontinuous reception state of the user equipment to the first base station device and the second base station device.

The apparatus may further comprise offset calculating processor adapted to calculate a relative offset time from a first offset time of the first base station device and a second offset time of the second base station device; wherein the activation request may comprise an offset information based on the relative offset time.

The apparatus may further comprise activation time calculating processor adapted to calculate an activation time based on a time required to distribute the activation request to the first and second base station devices, wherein the distributing processor may be adapted to provide the activation time to the first and second base station devices.

In the apparatus, the distributing processor may be adapted to distribute the activation request based on a DTX/DRX information received from the first base station device.

According to the seventh aspect of the invention, there is provided a system, comprising a primary apparatus according to any of the first and second aspects; an assisting apparatus according to any of the third and fourth aspects; and user equipment; wherein the user equipments performs the multi-flow communication with the primary apparatus and the assisting apparatus; the user equipment is adapted to receive the UE DTX/DRX activation request from the primary apparatus; the DTX/DRX information of the assisting apparatus is based on the DTX/DRX information provided by the primary apparatus.

According to an eighth aspect of the invention, there is provided a method, comprising performing a communication with a user equipment including a portion of a multi-flow communication to the user equipment; evaluating the communication with the user equipment; providing, a DTX/DRX information based on the evaluation, wherein the DTX/DRX information is related to at least one of a discontinuous transmission state and a discontinuous reception state of the user equipment; instructing to send an UE DTX/DRX activation request with respect to the at least one of the discontinuous transmission state and the discontinuous reception state according to the DTX/DRX information to the user equipment; storing a status information upon the instructing, wherein the status information comprises the at least one of the discontinuous transmission state and the discontinuous reception state corresponding to the instruction.

The method may be a method of discontinuous transmission or discontinuous reception.

In the method, the instructing may be based on the evaluation.

In the method, the DTX/DRX information may be provided to a control device, and the instructing may be based on an activation request received from the control device.

The method may further comprise calculating a relative offset time from a first offset time of the apparatus and a second offset time of a second base station device performing another portion of the multi-flow communication with the user equipment; calculating a time when the user equipment is ready to receive the multi-point communication based on the first offset time; transmitting to the user equipment only at the calculated time if the status information comprises the discontinuous reception state; wherein the DTX/DRX information may comprise an offset information related to the relative offset time.

The method may further comprise detecting an automatic repeat request activity from the user equipment; and changing the stored status information to neither of the discontinuous transmission state and the discontinuous reception state if the automatic repeat request activity is detected.

The method may further comprise calculating an activation time based on a time required to distribute the DTX/DRX information to a second base station device performing another portion of the multi-flow communication; wherein the method may be adapted to instruct only after the activation time has elapsed after the DTX/DRX information was provided; and the DTX/DRX information may comprise the activation time.

In the method, the activation request may comprise an activation time, and the method may be adapted to instruct only after the activation time has elapsed after the activation request was received.

The method may further comprise analyzing a channel quality indicator in a first way if the status information comprises the discontinuous transmission state, and in a second way different from the first way if the status information does not comprise the discontinuous transmission state, wherein the channel quality indicator may be received from the user equipment.

According to a ninth aspect of the invention, there is provided a method, comprising performing a communication with a user equipment including a portion of a multi-flow communication to the user equipment; storing, upon a received DTX/DRX information related to at least one of a discontinuous transmission state and a discontinuous reception state, a status information indicating that the user equipment is in the at least one of the discontinuous transmission state and the discontinuous reception state.

The method may be a method of discontinuous transmission or discontinuous reception.

The method may be adapted to transmit to the user equipment at transmission times if the status information does not comprise the discontinuous reception state, and at a subset of the transmission times if the status information comprises the discontinuous reception state.

In the method, the DTX/DRX information may comprise an offset information about a time offset, and the method may further comprise calculating the subset based on the offset information.

The method may further comprise detecting an automatic repeat request activity from the user equipment; and changing the stored status information to neither of the discontinuous transmission state and the discontinuous reception state if the automatic repeat request activity is detected.

The method may further comprise analyzing a channel quality indicator in a first way if the status information comprises the discontinuous transmission state, and in a second way different from the first way if the status information does not comprise the discontinuous transmission state, wherein the channel quality indicator may be received from the user equipment.

According to a tenth aspect of the invention, there is provided a method, comprising controlling a first communication of a first base station device with a user equipment and a second communication of a second base station device different from the first base station device with the user equipment, wherein the first communication and the second communication each comprise a respective, different, portion of a multi-flow communication with the user equipment; distributing an activation request related to at least one of a discontinuous transmission state and a discontinuous reception state of the user equipment to the first base station device and the second base station device.

The method may be a method of discontinuous transmission or discontinuous reception.

The method may further comprise calculating a relative offset time from a first offset time of the first base station device and a second offset time of the second base station device; wherein the activation request may comprise an offset information based on the relative offset time.

The method may further comprise calculating an activation time based on a time required to distribute the activation request to the first and second base station devices, wherein the method may comprise distributing the activation time to the first and second base station devices.

The method may be adapted to distribute the activation request based on a DTX/DRX information received from the first base station device.

According to an eleventh aspect of the invention, there is provided a computer program product including a program comprising software code portions being arranged, when run on a processor of an apparatus, to perform the method according to any one of the eighth to tenth aspects.

The computer program product may comprise a computer-readable medium on which the software code portions are stored, and/or the program may be directly loadable into a memory of the processor.

According to embodiments of the invention, at least the following advantages are achieved:

Battery savings in the UE are achieved without the need for reconfiguration to the FACH or PCH state, wherein the DTX/DRX state works properly even in case of a multi-flow operation.

It is to be understood that any of the above modifications can be applied sing-ly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows a sample DRX operation with two NodeBs according to an embodiment of the invention;

FIG. 2 shows a sample DRX operation with two NodeBs according to an embodiment of the invention;

FIG. 3 shows an apparatus according to an embodiment of the invention;

FIG. 4 shows a method according to an embodiment of the invention;

FIG. 5 shows an apparatus according to an embodiment of the invention;

FIG. 6 shows a method according to an embodiment of the invention;

FIG. 7 shows an apparatus according to an embodiment of the invention; and

FIG. 8 shows a method according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

According to embodiments of the invention, the conventional 3GPP UL DTX and DL DRX power saving schemes are performed and enhanced in conjunction with Multi-flow. In this following, we explain how the network may ensure a correct functioning of DTX/DRX in the distributed Multi-flow environment without introduction of any further changes at the UE side.

To simplify the presentation, embodiments of the invention are separately ex-plained for UL DTX and DL DRX. Please note that both UL DTX and DL DRX may be configured and activated for a UE, or that only one of these discontinuous states may be activated in the UE. However, in some embodiments like in the specific implementation of 3GPP TS 25.308, the DL DRX is activated only together with the UL DTX. In case of DL DRX, the NodeB should preferably transmit in a corresponding discontinuous mode (DL DTX) in order to not loose any communication by the UE.

### UL DTX

At a first glance, is seems that UL DTX operates straightforward with Multi-flow because it is only the UE who transmits discontinuously in the UL direc-tions, whereas the NodeB(s) anyway listen(s) continuously to the UL channel for any transmission happening there. From that point of view, the actual acti-vation status of the UL DTX, as decided by the primary NodeB, may be some-what irrelevant for the assisting NodeB(s). The primary NodeB is the NodeB activating the UL DTX and/or DL DRX state in the UE, whereas the primary NodeB and the assisting NodeB(s) send part of the application data of the Multi-flow communication independently over their wireless links. The UL DTX and/or DL DRX configuration may be provided by the RNC.

However, in case of Multi-flow, the assisting NodeB(s) listen for the UL chan-nels not only for the purpose of the UL power control, but also for the purpose of scheduling DL data, which is based on the received CQIs. More precisely, in case of Multi-flow, UE sends a compound CQI report that contains CQIs for both the primary and the assisting NodeBs. As a result, the assisting NodeB(s) may benefit from knowing whether UL DTX is on or off to optimize their internal CQI averaging algorithms, when the UE does not send UL CQI reports all the time.

More in detail, a first problem the assisting NodeB which does not know about UL DTX may face is wrong averaging filter. If you assume that normally (UL DTX deactivated) CQIs arrive every 2 ms, while they suddenly start to arrive every 10 ms due to activated UL DTX, then NodeB may unintentionally end up either forgetting the previous value too fast or on the contrary not updating it properly. Therefore, NodeB may adapt the averaging procedure appropriately. E.g., it may average over the last n CQI values instead over the last m CQI values (m>n) as normally, or it may just use the latest CQI value as an “aver-aged” CQI value. In the example above, m and n may be chosen as 10 and 2, respectively, or a multiple thereof. In addition, the NodeB knowing about UL DTX may adapt the weights for averaging appropriately. E.g., the relative weights of CQIs of the past may always be the same if the values are related to a certain time back into the past, irrespective of the number of CQI values received in between.

Another problem may be internal sanity checks by RRM in the assisting NodeB. If UL DTX is activated and this is not known to the assisting NodeB, the latter may mistakenly construe that a UE is loosing its UL connection if it does not receive CQIs as normally. Then, it may take appropriate actions, e.g. in prepa-ration of a handover. If the assisting nodeB knows that UL DTX is activated, the assisting NodeB may not construe missing CQIs as a lost UL connection.

Since according to embodiments of the invention the UL DTX configuration is provided by RNC, but is activated by the primary Node B, the latter informs changes in the UL DTX status to all the Node B(s) taking part in the Multi-flow operation. In some other embodiments, the RNC may make the UL DTX acti-vation/deactivation decision and then inform all the other NodeB(s). It should be noted that the activation/deactivation of the UL DTX configuration usually does not happen often, so any delay caused by the message flow over the Iub and possibly Iur interface should not impact the performance severely.

In some embodiments, changes in the UL DTX activation status may be signaled similar to the way it is done for the carrier activation status for DC-HSUPA. If the UL DTX activation/deactivation is decided by the NodeB RRM as it happens in the legacy system, the relevant signaling may be included in the Iub interface to inform other NodeB(s) configured with Multiflow for that particular UE.

In other embodiments, the UL DTX status may be decided by the RNC, potentially based on a request/indication from a NodeB, which propagates this decision to all the NodeB(s). Then, the primary NodeB may “forward” the activation/deactivation HS-SCCH order to a UE, thus making it, from the UE point of view, functionally basically the same as in the previous embodiment. One way is to use a mechanism similar to the one used for DC-HSUPA according to 3GPP TS 25.433, section 8.3.20. The related signaling is presented in section 9.1.92. There are two messages: one is to deliver an indication from NodeB to CRNC, and another one is to forward the same indication from CRNC to another NodeB.

### DL DRX

The DL DRX operation in the Multi-flow case is more challenging due to the fact that a UE enters the DRX state based on the DL HS-SCCH channel activity, which is not visible to the assisting NodeB(s) configured for Multi-flow with the UE. So, while a NodeB may think that the UE has entered the DL DRX cycle because of absence of activity on its own HS-SCCH channel, the UE may in fact listen continuously for DL channel due to the HS-SCCH activity coming from another NodeB. This case does not create any fundamental problems because even if the NodeB assumes that the UE is DL DRX:ing (assumes the discontinuous reception state) although the latter is not, the UE will anyway receive the HS-SCCH from the aforementioned NodeB when this NodeB transmits it on the UE DL DRX “listening” time. If neither of the NodeB(s) transmit in the DL direction thus indeed resulting in the UE entering the DRX cycle, then still it does not cause any state un-synchronization issues as long as all the NodeB(s) use the same DL DRX parameters (in particular DRX cycle and on-duration timer) and CFN number to calculate the DRX listening time.

The CFN numbers are used to define the relevant times for the DRX cycle and may be different for different cells for the following reason: While connected to a cell, the UE maintains the CFN which is based upon the cell's SFN. When the UE is handed off to a new cell while in the CELL_DCH state, it can be ordered to maintain its CFN counter (continue to increase CFN by 1 every frame) or to re-initialize it based on the SFN of the target cell (the UE must read the BCCH of the target cell to do so). The UE is ordered to maintain or re-initialize its CFN counter by the Timing Indication information element sent in the message that initiates the handover.

Thus, in Multi-flow, and especially in the inter-site case, the assisting cells may be not time-synchronized with the primary serving cell—an arbitrary frame offset may exist. The offset is however known at least to the UE, and also to the RNC. This offset also may be taken into account by the NodeB(s) when determining the UE DRX cycles.

Similar to the UL DTX case, the general parameters for DL DRX are provided by RNC, whereas in some embodiments the activation of the DL DRX configuration, after which a UE starts to monitor the HS-SCCH channel activity at specified times, may be decided by the primary NodeB, which in turn informs all the assisting NodeB(s) about it. In other embodiments, the RNC may acti-vate/deactivate DL DRX and let all the NodeB(s) participating in the multi-flow communication to know about this decision.

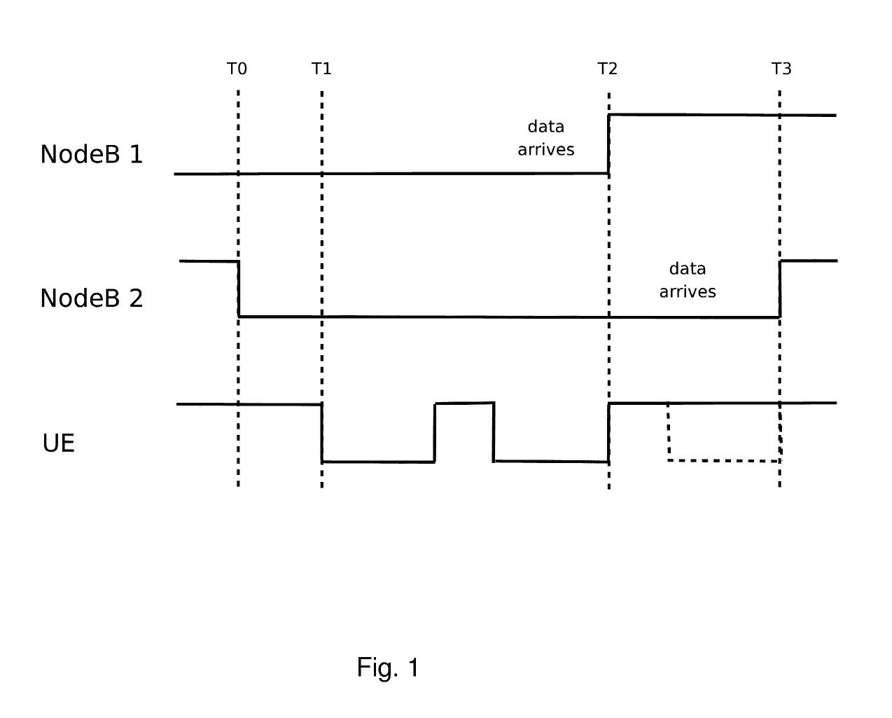

FIG. 1 shows a DRX operation example of an embodiment of the invention comprising NodeB 1 and NodeB 2 making up a multi-flow communication with a UE. Referring to FIG. 1, suppose that NodeB 2 stops scheduling data at T0. Once the UE DRX inactivity timeout expires, it will enter the DRX mode at T1, thus listening to the DL HS-SCCH channel only at particular moments of time that are synchronized between the two NodeBs. Once NodeB 1 wants to send DL data, it has to wait for the next DRX “listening time”; it happens at T2. Note that NodeB 2 is not aware of the fact that the UE has quit DRX. However, if NodeB 2 wants to send some data later, it just has to wait for the moment of time, T3, where the UE would listen for the DL channel as if it were in the DRX cycle. The delay caused by this fact can be bounded by the time between the UE listening occasions.

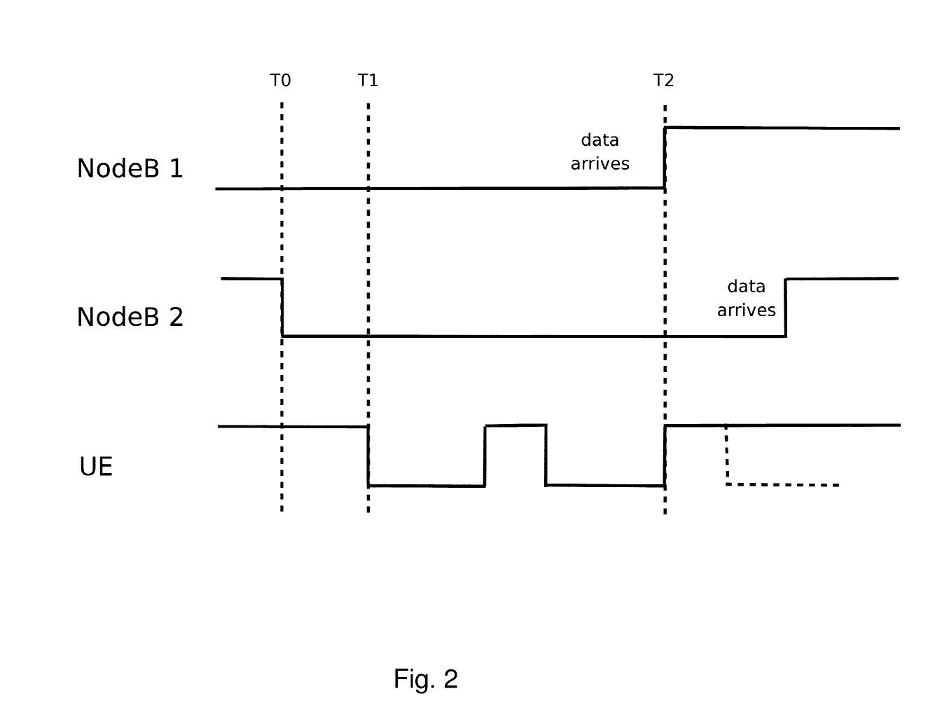

According to some embodiments, an optimization is employed by which a NodeB (in the above example: NodeB 2) may run the DL DRX more efficiently in the Multi-flow case. Even though the NodeB is not aware of another NodeB's (in the above example: NodeB 1) HS-SCCH activity, it still receives and listens to the UE UL HS-DPCCH channel, over which both CQIs and HARQ ACK/NACK messages are transmitted. If the NodeB detects the HARQ ACK/NACK message designated for another cell, i.e., caused by the HS-SCCH coming from another NodeB, then it may construe that the UE has quit the DL DRX cycle and, as a result, may listen continuously for the DL channel, i.e. it may deactivate DL DRX for itself. In this case, the NodeB may avoid waiting for the next DL DRX listening occasion if it has data to transmit. Referring to the FIG. 2, NodeB2 may detect that a UE has quit the DRX at the moment of time T2. Thus, it may not wait for T3, as in FIG. 1, if some data arrives, but may schedule these data immediately. In analogy, the NodeB1 in the above example may listen to the HARQ ACK/NACK transmitted in the UL HS-DPCCH channel as a result of the DL activity from NodeB2.

For the DL DRX to function correctly with the inter-site Multiflow operation, one may ensure that NodeB(s) residing in different sites use the same CFN number to determine the DRX listening time. However, the CFN number is UE and cell specific. On the other hand, the CFN number is assigned by RNC and signaled to both UE and NodeB(s). Thus, at least one of two possible solutions may be provided in different embodiments of the invention:

With the first solution, while assigning the CFN number to a UE, the RNC just ensures that it is the same for all the NodeB(s). With the other solution, RNC knowing the UE CFN number in each cell, may just signal the CFN offset to other NodeB(s) for them to calculate the “virtual” CFN for the purpose of the DRX.

According to some embodiments of the invention, changes in the DL DRX acti-vation status may be signaled similar to the way it is done for the carrier acti-vation status for DC-HSUPA (see e.g. 3GPP TS 25.433). If the DL DRX activation/deactivation is decided by the NodeB RRM as it happens in the legacy system, the relevant signaling may be introduced for the Iub interface to inform other NodeB(s) configured with Multi-flow for that particular UE.

An alternative solution according to some embodiments of the invention is that DL DRX status is decided by the RNC, potentially based on a request/indication from the primary NodeB, wherein either the RNC or the primary NodeB may propagate this decision to all the NodeB(s) participating in the Multi-flow communication. Then, the primary NodeB may “forward” the activation/deactivation HS-SCCH order to a UE, thus making it functionally basically the same from the UE point of view.

Regardless of the aforementioned solution taken, either the primary NodeB or the RNC should preferably provide a so-called activation time in order to avoid a situation when, say, the primary NodeB activates the DL DRX via the HS-SCCH order and a UE enters almost immediately the DL DRX cycle due to a possible small inactivity timeout. In this case, it may happen that the DL DRX activation indication reaches the other NodeB some time later, thus possibly resulting in a situation that the other NodeB tries to schedule data while a UE does not listen to the DL HS-SCCH channel. As an example, the DL DRX acti-vation order is to be applied within the 12 slots, i.e., 8 ms. The smallest DL DRX inactivity time is according, to TS 25.331, 1 subframe, e.g., 2 ms. So, if takes more than 10 ms to deliver the DL DRX activation status to a NodeB in a different site, the latter can start to schedule data whereas a UE will not listen to the HS-SCCH channel. Therefore, in some embodiments, either the primary NodeB or the RNC may send the activation command to the UE only after it has waited for the activation time after it has distributed the decision to all the participating NodeBs.

In addition, in some embodiments, NodeB taking part in the Multi-flow operation may listen to the UE UL HS-DPCCH channel and once the HARQ activity is detected there based on the HARQ ACK/NACKs sent by the UE for other cells, NodeB may construe that the UE has quit the DL DRX and now listens continuously for the DL channel. To avoid unnecessary processing of the HS-DPCCH HARQ ACK/NACKs all the time, in some embodiments NodeB may do it only when it receives the indication from the primary NodeB (or RNC) that the DL DRX status is active.

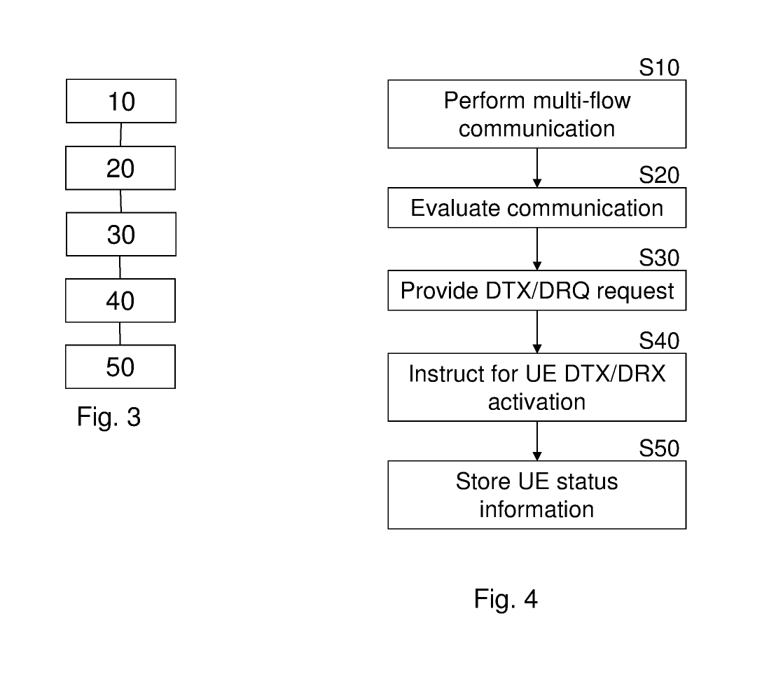

FIG. 3 shows an apparatus according to an embodiment of the invention. The apparatus may be a base station, in particular a primary NodeB. FIG. 4 shows a method according to an embodiment of the invention. The apparatus according to FIG. 3 may perform the method of FIG. 4 but is not limited to this method. The method of FIG. 4 may be performed by the apparatus of FIG. 3 but is not limited to being performed by this apparatus.

The apparatus comprises multi-flow communicating means 10, evaluating means 20, providing means 30, instructing means 40, and storing means 50. With the multi-flow communicating means 10, the apparatus may communi-cate with a user equipment, and in particular participate in a multi-flow communication with the user equipment (S10). The evaluating means 20 may evaluate the communication with the user equipment (S20). Thus, it may detect whether UL DTX and/or DL DRX should be activated in the UE.

If a result of the evaluation is, for example, that the UL DTX and/or DL DRX should be activated, the providing means 30 may provide a DTX/DRX request, which is related to the UL DTX and/or DL DRX state according to the evaluation by the evaluation means 20 (S30). The DTX/DRX request may be provided to the RNC or to another NodeB participating in the multi-flow communication with the UE.

The instructing means 40 may instruct the multi-flow communicating means 10 to send an UE DTX/DRX activation request to the UE (S40). By the UE DTX/DRX activation state, the UE is instructed to switch into the DTX and/or DRX state according to the DTX/DRX request provided by the providing means 30. The instructing means 40 may instruct sending the UE DTX/DRX activation state either based on the evaluation by the evaluation means 20 or based on an activation request received e.g. from a controller device such as an RNC.

The storing means 50 may store a status information corresponding to the instruction from the instructing means 40 (S50).

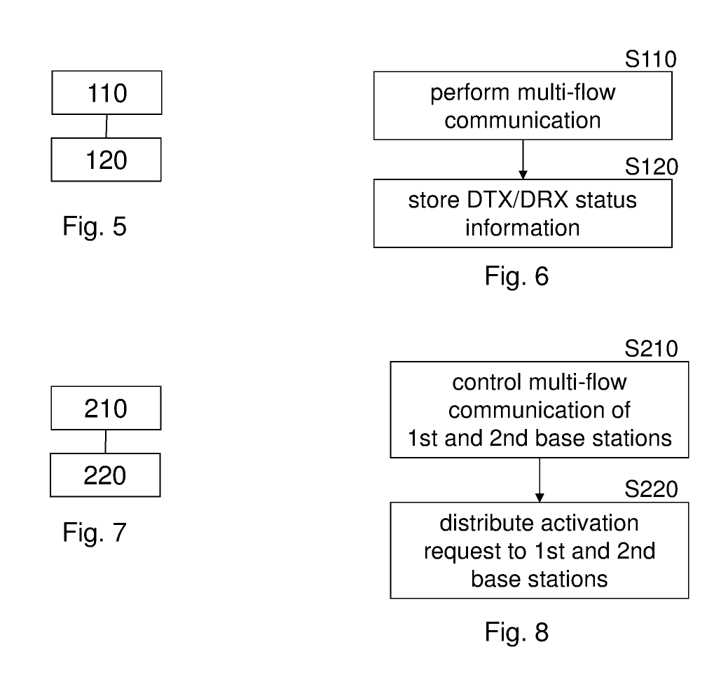

FIG. 5 shows an apparatus according to an embodiment of the invention. The apparatus may be a base station, in particular an assisting NodeB. FIG. 6 shows a method according to an embodiment of the invention. The apparatus according to FIG. 5 may perform the method of FIG. 6 but is not limited to this method. The method of FIG. 6 may be performed by the apparatus of FIG. 5 but is not limited to being performed by this apparatus.

The apparatus comprises multi-flow communicating means 110 and storing means 120.

With the multi-flow communicating means 110, the apparatus may communi-cate with a user equipment, and in particular participate in a multi-flow communication with the user equipment (S110).

Upon receipt of an activation request which is related to at least one of a DTX state and a DRX state (in particular to at least one of a UL DTX state and a DL DRX state), the storing means 120 may store a corresponding status information (S120). I.e., the status information indicates that the UE is in the DTX and/or DRX state to which the activation request is related. For example, the status may have the following structure:
discontinuous transmission: yes or no;
discontinuous reception: yes or no.

Another equivalent structure may have the following values: discontinuous transmission; discontinuous reception; discontinuous transmission and discontinuous reception; neither discontinuous transmission nor discontinuous reception (normal state).

FIG. 7 shows an apparatus according to an embodiment of the invention. The apparatus may be a controller such as a radio network controller or RNC. FIG. 8 shows a method according to an embodiment of the invention. The apparatus according to FIG. 7 may perform the method of FIG. 8 but is not limited to this method. The method of FIG. 8 may be performed by the apparatus of FIG. 7 but is not limited to being performed by this apparatus.

The apparatus comprises controlling means 210 and distributing means 220.

The controlling means 210 controls the communications of plural base stations with a user equipment, wherein the communications may comprise respective parts of a multi-flow communication with the user equipment (S210). The distributing means 220 may distribute an activation request related to DTX and/or DRX to the base stations communicating with the user equipment (S220).

Embodiments of the invention are described based on a release 11 system but embodiments of the invention may be applied to other releases and other radio access technologies such as LTE, WiFi, WLAN, UMTS, HSPA, comprising multi-flow communication and at least one of a discontinuous transmission and discontinuous reception.

A UE may be a user equipment, a terminal, a mobile phone, a laptop, a smart-phone, a tablet PC, or any other device that may attach to the mobile network. A base station may be a NodeB, an eNodeB or any other base station of a radio network enabling a multi-flow communication and at least one of a discontinuous transmission and discontinuous reception.

If not otherwise stated or otherwise made clear from the context, the state-ment that two entities are different means that they are differently addressed in their respective network. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a base station apparatus such as a NodeB or an eNodeB, or a component thereof, an apparatus embodying the same, a method for controlling and/or operating the same, and computer program(s) controlling and/or operating the same as well as mediums carrying such computer program(s) and forming computer program product(s). Furthermore, it should thus be apparent that exemplary embodiments of the present invention provide, for example a controller apparatus such as a radio network controller, a RNC, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. Apparatus, comprising
multi-flow communicating means adapted to perform a communication with a user equipment including a portion of a multi-flow communication to the user equipment;
evaluating means adapted to evaluate the communication with the user equipment;
providing means adapted to provide a DTX/DRX information based on the evaluation, wherein the DTX/DRX information is related to at least one of a discontinuous transmission state and a discontinuous reception state of the user equipment;
instructing means adapted to instruct the multi-flow communicating means to send an UE DTX/DRX activation request with respect to the at least one of the discontinuous transmission state and the discontinuous reception state according to the DTX/DRX information to the user equipment;
storing means adapted to store a status information upon the instructing by the instruction means, wherein the status information comprises the at least one of the discontinuous transmission state and the discontinuous reception state corresponding to the instruction by the instructing means.

2. The apparatus according to claim 1, wherein the instructing means is adapted to instruct the multi-flow communicating means based on the evaluation.

3. The apparatus according to claim 1, wherein
the providing means is adapted to provide the DTX/DRX information to a control device, and
the instructing means is adapted to instruct the multi-flow communicating means based on an activation request received from the control device.

4. The apparatus according to claim 1, further comprising
offset calculating means adapted to calculate a relative offset time from a first offset time of the multi-flow communicating means and a second offset time of a second base station device performing another portion of the multi-flow communication with the user equipment;
calculating mea ns adapted to calculate a time when the user equipment is ready to receive the multi-point communication based on the first offset time; wherein
the multi-flow communicating means is adapted to transmit to the user equipment only at the calculated time if the status information comprises the discontinuous reception state, and
the DTX/DRX information comprises an offset information related to the relative offset time.

5. The apparatus according to claim 1, further comprising
HARQ detecting mea ns adapted to detect an automatic repeat request activity from the user equipment; and
status changing mea ns adapted to change the stored status information to neither of the discontinuous transmission state and the discontinuous reception state if the automatic repeat request activity is detected.

6. The apparatus according to claim 1, further comprising
activation time calculating means adapted to calculate an activation time based on a time required to distribute the DTX/DRX information to a second base station device performing another portion of the multi-flow communication, wherein
the DTX/DRX information comprises the activation time, and the instructing means is adapted to instruct the multi-flow communicating mea ns only after the activation time has elapsed after the DTX/DRX information was provided.

7. The apparatus according to claim 3, wherein the activation request comprises an activation time, and the instructing means is adapted to instruct the multi-flow communicating mea ns only after the activation time has elapsed after the activation request was received.

8. The apparatus according to claim 1, further comprising
analyzing means adapted to analyze a channel quality indicator in a first way if the status information comprises the discontinuous transmission state, and in a second way different from the first way if the status information does not comprise the discontinuous transmission state, wherein the channel quality indicator is received from the user equipment.

9. Apparatus, comprising
multi-flow communicating means adapted to perform a communication with a user equipment including a portion of a multi-flow communication to the user equipment;
storing means adapted to store, upon a received DTX/DRX information related to at least one of a discontinuous transmission state and a discontinuous reception state, a status information indicating that the user equipment is in the at least one of the discontinuous transmission state and the discontinuous reception state.

10. The apparatus according to claim 9, wherein
the multi-flow communicating means is adapted to transmit to the user equipment at transmission times if the status information does not comprise the discontinuous reception state, and at a subset of the transmission times if the status information comprises the discontinuous reception state.

11. The apparatus according to claim 10, wherein
the DTX/DRX information comprises a n offset information about a time offset, and the apparatus further comprises
calculating means adapted to calculate the subset of times based on the offset information.

12. The apparatus according to claim 9, further comprising
HARQ detecting mea ns adapted to detect an automatic repeat request activity from the user equipment; and
status changing means adapted to change the stored status information to neither of the discontinuous transmission state and the discontinuous reception state if the automatic repeat request activity is detected.

13. The apparatus according to claim 9, further comprising
analyzing means adapted to analyze a channel quality indicator in a first way if the status information comprises the discontinuous transmission state, and in a second way different from the first way if the status information does not comprise the discontinuous transmission state, wherein the channel quality indicator is received from the user equipment.

14. Apparatus, comprising
controlling means adapted to control a first communication of a first base station device with a user equipment and a second communication of a second base station device different from the first base station device with the user equipment, wherein the first communication and the second communication each comprise a respective, different, portion of a multi-flow communication with the user equipment;
distributing means adapted to distribute an activation request related to at least one of a discontinuous transmission state and a discontinuous reception state of the user equipment to the first base station device and the second base station device.

15. The apparatus according to claim 14, further comprising
offset calculating means adapted to calculate a relative offset time from a first offset time of the first base station device and a second offset time of the second base station device; wherein
the activation request comprises an offset information based on the relative offset time.

16. The apparatus according to claim 14, further comprising
activation time calculating means adapted to calculate an activation time based on a time required to distribute the activation request to the first and second base station devices, wherein
the distributing means is adapted to provide the activation time to the first and second base station devices.

17. The apparatus according to claim 14, wherein
the distributing means is adapted to distribute the activation request based on a DTX/DRX information received from the first base station device.

18. (canceled)

19. Method, comprising
performing a communication with a user equipment including a portion of a multi-flow communication to the user equipment;
evaluating the communication with the user equipment;
providing, a DTX/DRX information based on the evaluation, wherein the DTX/DRX information is related to at least one of a discontinuous transmission state and a discontinuous reception state of the user equipment;
instructing to send a n U E DTX/DRX activation request with respect to the at least one of the discontinuous transmission state and the discontinuous reception state according to the DTX/DRX information to the user equipment;
storing a status information upon the instructing, wherein the status information comprises the at least one of the discontinuous transmission state and the discontinuous reception state corresponding to the instruction.

20. The method according to claim 19, wherein the instructing is based on the evaluation.

21. The method according to claim 19, wherein
the DTX/DRX information is provided to a control device, and
the instructing is based on an activation request received from the control device.

22. The method according to claim 19, further comprising
calculating a relative offset time from a first offset time of the apparatus and a second offset time of a second base station device performing another portion of the multi-flow communication with the user equipment;
calculating a time when the user equipment is ready to receive the multi-point communication based on the first offset time;
transmitting to the user equipment only at the calculated time if the status information comprises the discontinuous reception state; wherein
the DTX/DRX information comprises an offset information related to the relative offset time.

23. The method according to claim 19, further comprising
detecting an automatic repeat request activity from the user equipment; and
changing the stored status information to neither of the discontinuous transmission state and the discontinuous reception state if the automatic repeat request activity is detected.

24. The method according to claim 19, further comprising
calculating an activation time based on a time required to distribute the DTX/DRX information to a second base station device performing another portion of the multi-flow communication; wherein
the method is adapted to instruct only after the activation time has elapsed after the DTX/DRX information was provided; and
the DTX/DRX information comprises the activation time.

25. The method according to claim 21, wherein the activation request comprises an activation time, and the method is adapted to instruct only after the activation time has elapsed after the activation request was received.

26. The method according to claim 19, further comprising
analyzing a channel quality indicator in a first way if the status information comprises the discontinuous transmission state, and in a second way different from the first way if the status information does not comprise the discontinuous transmission state, wherein the channel quality indicator is received from the user equipment.

27. Method, comprising
performing a communication with a user equipment including a portion of a multi-flow communication to the user equipment;
storing, upon a received DTX/DRX information related to at least one of a discontinuous transmission state and a discontinuous reception state, a status information indicating that the user equipment is in the at least one of the discontinuous transmission state and the discontinuous reception state.

28. The method according to claim 27, wherein
the method is adapted to transmit to the user equipment at transmission times if the status information does not comprise the discontinuous reception state, and at a subset of the transmission times if the status information comprises the discontinuous reception state.

29. The method according to claim 28, wherein
the DTX/DRX information comprises an offset information about a time offset, and the method further comprises
calculating the subset based on the offset information.

30. The method according to claim 27, further comprising
detecting an automatic repeat request activity from the user equipment; and
changing the stored status information to neither of the discontinuous transmission state and the discontinuous reception state if the automatic repeat request activity is detected.

31. The method according to claim 27, further comprising
analyzing a channel quality indicator in a first way if the status information comprises the discontinuous transmission state, and in a second way different from the first way if the status information does not comprise the discontinuous transmission state, wherein the channel quality indicator is received from the user equipment.

32. Method, comprising
controlling a first communication of a first base station device with a user equipment and a second communication of a second base station device different from the first base station device with the user equipment, wherein the first communication and the second communication each comprise a respective, different, portion of a multi-flow communication with the user equipment;
distributing an activation request related to at least one of a discontinuous transmission state and a discontinuous reception state of the user equipment to the first base station device and the second base station device.

33. The method according to claim 32, further comprising
calculating a relative offset time from a first offset time of the first base station device and a second offset time of the second base station device; wherein
the activation request comprises an offset information based on the relative offset time.

34. The method according to claim 32, further comprising
calculating an activation time based on a time required to distribute the activation
request to the first and second base station devices, wherein the method comprises distributing the activation time to the first and second base station devices.

35. The method according to claim 32, wherein
the method is adapted to distribute the activation request based on a DTX/DRX information received from the first base station device.

36. A computer program product including a program comprising software code portions being arranged, when run on a processor of an apparatus, to perform the method according to claim 19.

37. The computer program product according to claim 36, wherein the computer program product comprises a computer-readable medium on which the software code portions are stored, and/or wherein the program is directly loadable into a memory of the processor.
